(19) United States
(12) Patent Application Publication
(10) Pub. No.: US 2003/0223222 A1
(43) Pub. Date: Dec. 4, 2003

(54) Structure to emit colorful light from an exhaust pipe

(76) Inventor: Wen-Cheng Yu, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/157,150

(22) Filed: May 30, 2002

(51) Int. Cl. F21V 33/00; F21S 4/00

(52) U.S. Cl. 362/96; 362/89; 362/234

(57) ABSTRACT

A structure to emit colorful light from an exhaust pipe includes an inner tube, an outer tube rear section, an outer tube front section, an annular circuit board, LEDs, and a retaining ring, wherein the outer tube rear section is securely connected to the inner tube, and one end of the outer tube rear section is riveted to the outer tube front section, the outer tube front section has a reduced section end and a circular groove for the annular circuit board to seat therein and is secured by a retaining ring, a number of LEDs are placed on the annular circuit board, the annular circuit board on the outer tube front section remains a space with the inner tube, and the outer tube rear section comprises a plurality of slots and the far end is formed with a reduced section, which also comprises holes thereat.

### FIELD OF THE INVENTION

This invention relates to an exhaust pipe, and more particularly to an exhaust pipe has prearranged with holes and slots to produce turbulence when exhaust gas expelled from the pipe and with the arrangement of LEDs to emit multi-colorful light.

### BACKGROUND OF THE INVENTION

There is a prior exhaust pipe, which can emit light to attract consumers' attention. This design comprises an inner tube secured to one end of the exhaust pipe with an outer tube connected to the inner tube, the outer tube comprises neon lamps attached thereto and separated from the inner tube to form a gap there between as a waist gas passage, thus when air flows through the passage, the projection light forms neon light beaming.

However, this design of installing the neon lamps is complicated and to place the neon lamps is extremely dangerous and easy to be broken.

### SUMMARY OF THE INVENTION

It is the primary object to provide a structure to emit colorful light from an exhaust pipe, which emits colorful light in varies shapes that is more attractive to customers.

It is another object of the present invention to provide a structure to emit colorful light from an exhaust pipe, which is easy to install.

It is a further object of the present invention to provide a structure to emit colorful light from an exhaust pipe, which is safe in use and the lamps are more protected.

### BRIEF DESCRIPTION OF THE DRAWINGS

FIG. 1 is a perspective view of the present invention;

FIG. 2 is a side sectional view of FIG. 1, partially sectioned; and

FIG. 3 is another side sectional view of the present invention.

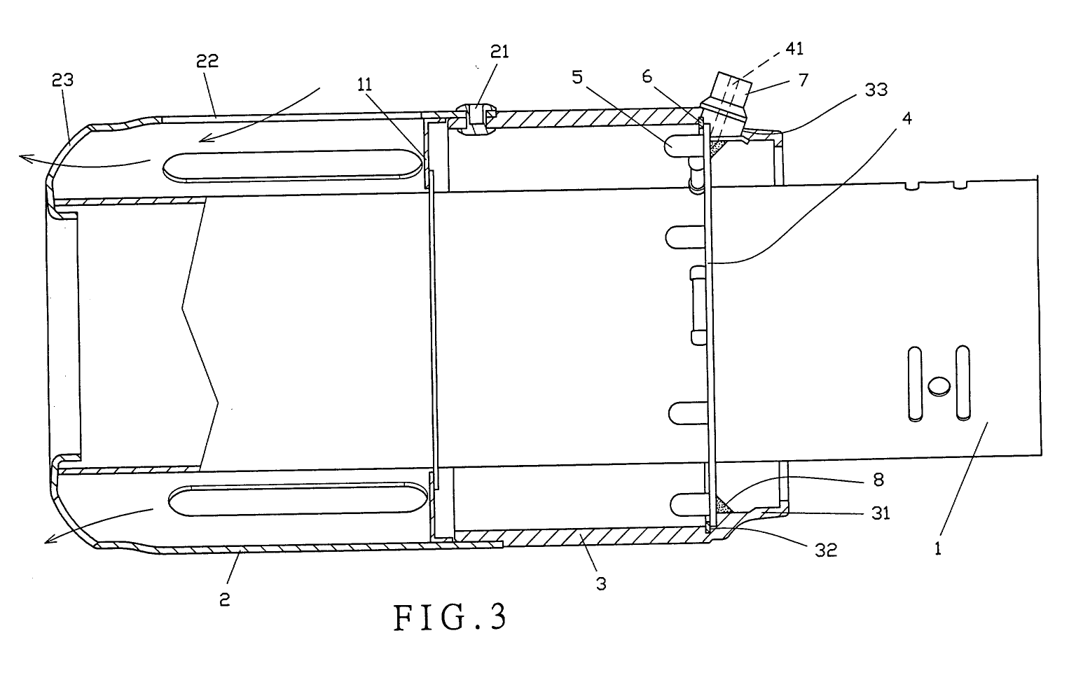

### DETAILED DESCRIPTION OF THE PREFERRED EMBODIMENTS

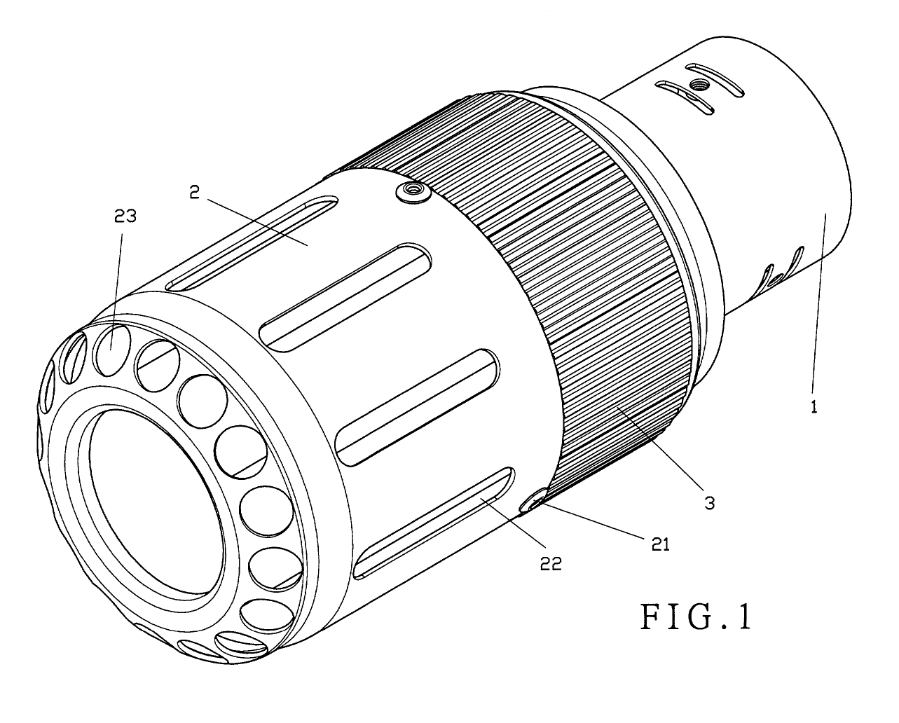

A structure to emit colorful light from an exhaust pipe of the present invention, as shown in FIG. 1, comprises an inner tube 1, an outer tube rear section 2, an outer tube front section 3, an annular circuit board 4, LEDs 5, a retaining ring 6, an isolating sleeve 7, and water proof glue 8.

The inner tube 1 has a fixture 11 at its outer surface adapted to secure inside of the outer tube rear section 2.

The outer tube rear section 2 has one end secured to the outer tube front section 3 by means of rivets 21, the outer tube rear section 2 comprises a plurality of slots 22 around the periphery and a reduced end with holes 23 thereon.

The outer tube front section 3 has a reduced end forming a step 31 in the inner portion of the reduced end to engage the annular circuit board 4 thereto. At the front end close to the step 31 is a groove 32 adapted to receive the annular circuit board 4 therein and secured by the retaining ring 6. The front end of the outer tube front section 3 has a hole 33 for the isolating sleeve 7.

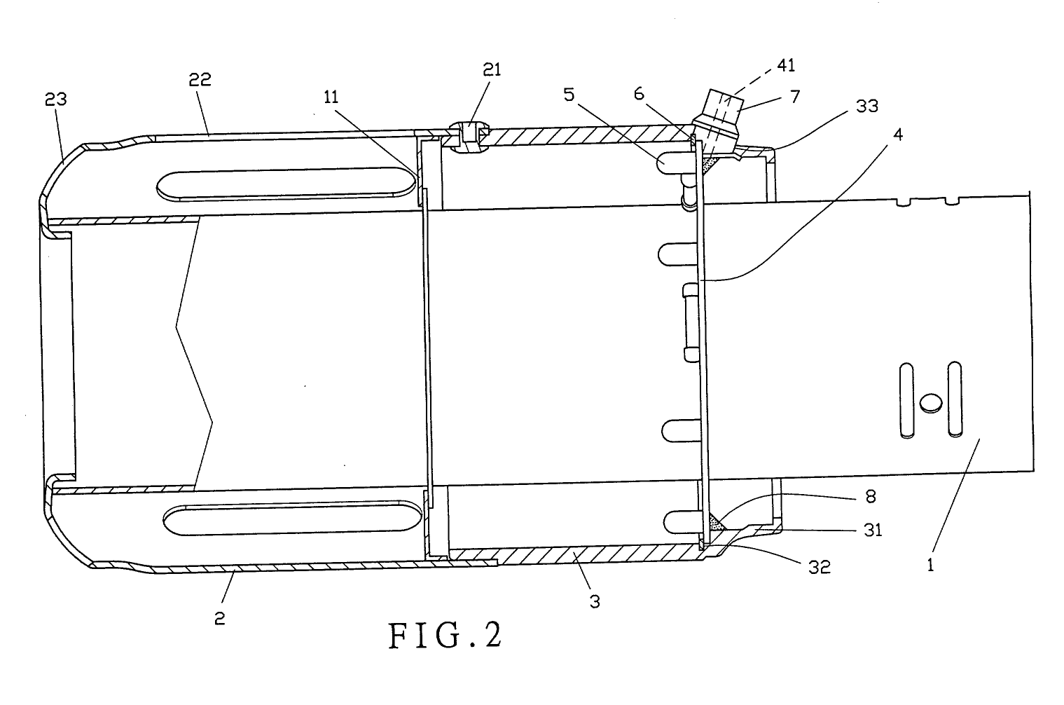

The annular circuit board 4 comprises a number of LEDs 5 thereon connected with an electric wire 41 sleeved into the isolating sleeve 7, as shown in FIG. 2. The connecting area between the annular circuit board 4 and the step 31 of the outer tube front section 3 is glued with water-proof glue 8.

With the above arrangement, there is a gap between the annular circuit board 4 on the outer tube front section 3 and the inner tube 1, which is treated as air passage.

The air flows into the slots 23 of the outer tube rear section 2 and comes out from the holes 23 of the outer tube rear section 2, which is mixed with the waste gas expelled from the inner tuber 11 to produce turbulence, which produces various colorful light when lit by the LEDs 5.

I claim:

1. A structure to emit colorful light from an exhaust pipe comprising an inner tube, an outer tube rear section, an outer tube front section, an annular circuit board, LEDs, and a retaining ring, wherein
said inner tube comprising a fixture to secure inside of said outer tube rear section;
said outer tube rear section having one end riveted to said outer tube front section;
said outer tube front section having a step at inside of a reduced end for said annular circuit board to engage thereto, and a groove at a front end close to said step adapted to secure said annular circuit board therein and secured with a retaining ring;
said annular circuit board comprising LEDs electrically connected thereon; whereas, a gap being formed between said inner tube and said annular circuit board on said outer tube front section, and being characterized in that:
said outer tube rear section having a plurality of slots around the periphery, and one end of said outer tube rear section being a reduced end with holes thereon.
